(19) United States
(12) Patent Application Publication
(10) Pub. No.: US 2015/0006485 A1
(43) Pub. Date: Jan. 1, 2015

(54) High Scalability Data Management Techniques for Representing, Editing, and Accessing Data

(71) Applicant: Eric Alan Christiansen, Pittsburg, CA (US)

(72) Inventor: Eric Alan Christiansen, Pittsburg, CA (US)

(73) Assignee: Eric Alan Christiansen, Pittsburg, CA (US)

(21) Appl. No.: 13/928,225

(22) Filed: Jun. 26, 2013

(51) Int. Cl. G06F 17/30

(52) U.S. Cl. CPC G06F 17/30368
USPC 707/625

(57) ABSTRACT

Techniques are described which allow logical informational elements to be added, changed, erased and queried using only physical data append and read operations. A full change history is also maintained. Data can be saved to any computer data store, including memory, disk, and even a data stream to another program or system. Even media or communications supporting only data append operations can be used. To read information special read techniques are described which allow reading of current information only, information as of a particular point in time, a change history of information over time or information from certain sources only. Associated data quality techniques are described for correcting data and/or analyzing data and/or processing quality metrics. Associated data synchronization techniques are described for propagating logical add/change/delete transactions to other systems in a manner that only require physical data append operations by the receiver.

### CROSS-REFERENCE TO RELATED APPLICATIONS

This application claims the benefits of U.S. Provisional Application No. 61/738,130, filed Dec. 17, 2012, the disclosure of which is incorporated herein by reference.

### BACKGROUND

High volume and/or high performance data management systems often process add-only or append-only operations much faster than change or delete operations. Some data stores and associated data management systems do not even support normal change or delete operations. If information is additive only there is no real problem in using append-only operations and/or technologies. However, if information changes or needs to be deleted there is a problem trying to use the faster append-only operations and/or technologies. In addition, if an audit log of changes and deletes is desired this generally introduces more overhead which can adversely affect performance and throughput.

### BRIEF SUMMARY OF THE INVENTION

High Scalability Data Management Techniques for Representing, Editing, and Accessing Data are described. By utilizing these techniques, the efficiency by which data (i.e., information) can be stored, edited and/or accessed (e.g., read and/or queried) can be significantly increased.

More particularly, data can be represented by associating one or more control columns with data columns in a table. Individual information elements (e.g., records or portions of records) of the data can then be logically edited (e.g., added, changed or modified, and/or deleted) by utilizing append-only operations to physically insert an information element into the table. As a result, operations such as physical data update and delete operations are not necessary to store, edit, and/or access the data in the table during normal operations, thus avoiding the resources and longer operation times associated with these operations. In at least one embodiment, the data represented in the table can be queried or otherwise accessed to provide current information, information as of a certain point in time, information changes over time, or information from select sources only. For example, values in individual control columns associated with informational elements inserted using append-only operations can be utilized to identify and access this information.

In addition, in at least one embodiment a data quality process can be implemented.

In addition, in at least one embodiment a data synchronization process can be implemented.

In accordance with the described techniques, data can be targeted towards any data store or data stream, including in-memory or on-disk storage or network transmission.

Furthermore, a set of non-limiting implementation examples are described which demonstrate implementing these processes using common SQL commands. However, it is to be appreciated and understood that the described techniques are not limited to being implemented using SQL databases. Non-SQL data management systems can also alternatively or additionally be utilized to implement these techniques.

This summary is provided as a quick introduction to select concepts. These and other concepts are described at greater length in the Detailed Description section below. This summary is not intended to identify key features or essential features, nor is it intended to aid in determining the scope of the claimed subject matter.

### BRIEF DESCRIPTION OF THE DRAWINGS

FIG. 1 illustrates example logical data edit operations, in accordance with at least one embodiment.

FIG. 2 illustrates an example association of payload data columns with control columns in a table, in accordance with at least one embodiment.

FIG. 3 illustrates raw physical data in a data store for detailed read query examples.

FIG. 4 illustrates a dynamic view of raw data with the addition of the calculated next_as_of column.

FIG. 5 illustrates a dynamic view of raw data with the addition of the calculated next_as_of column but with no null values.

FIG. 6 illustrates the dynamic query results of a “as when” query.

FIG. 7 illustrates the dynamic query results of a current, or “now”, query.

FIG. 8 illustrates an example environment in which the described techniques can be implemented, in accordance with at least one embodiment.

### DETAILED DESCRIPTION

### Overview

Data management techniques for representing, editing, and accessing data are described. By utilizing these techniques, the efficiency by which data (i.e., information) can be stored, edited, and/or accessed (e.g., read and/or queried) can be significantly increased. Furthermore, a full change history can also be maintained. The data can be saved to any computer data store, including memory, disk, and/or even a data stream to another program or system. Even media or communications supporting only data append operations can be used.

More particularly, data can be represented by associating one or more control columns with base data columns (i.e., payload data columns) in a data store (e.g., a file, database table or communication record). Individual information elements (e.g., rows, columns, records or portions of records, etc.) of the data can then be logically edited (e.g., added, changed or modified, and/or deleted) by utilizing append-only operations to physically insert informational elements into the data store. As a result, operations such as physical data update and delete operations are not necessary to store, edit, or access the data during normal operations, thus eliminating the resources and/or longer operation times associated with these operations.

In at least one embodiment, a data store with one or more data columns and one or more control columns can be created to represent data received from a source. Each data column(s) can represent a data store field (e.g., raw data feed file field) provided with the received data that describes an aspect of the data. Each control column(s) can represent supplemental meta-data (i.e., data about the data). For each row of the table, a value can be set in each field of each control column that designates a particular meta-data characteristic for that row. Each value (i.e., control column value) can be set when or after payload data is received (e.g. automatically by a database system or load program when the data is loaded). For instance, in at least one embodiment, default control column field values can be defined.

Once the data store has been created, in at least one embodiment the information represented in the data store can be maintained using only append-only operations.

For example, new data (new information) can be added to the data store by utilizing an append-only operation to insert (append) a new row with payload columns set with new base information values and control columns set with appropriate meta-data values.

Alternatively or additionally, existing data (information) can be logically changed by utilizing an append-only operation to insert (append) a new superceding row with payload columns set with new base information values and control columns set with appropriate new meta-data values.

Alternatively or additionally, existing data (information) can be logically deleted by utilizing an append-only operation to insert (append) a new delete-indicating row with payload columns set with new base information values and control columns set with appropriate new meta-data values (e.g., the “del” delete indicator control column set to true).

In at least one embodiment, the data represented in the table can queried, read, and/or otherwise accessed to provide current information, information as of a certain point in time, information changes over time, or information from select sources only. For example, control column values associated with informational payload elements inserted using an append-only operation can be utilized to identify (e.g., search for and discover) and access this information. As such, the data can be queried and the individual columns can be utilized to discover and return a history of add, changes and deletes to the base data over time from any or all information sources as the query's result.

In addition, in at least one embodiment a data quality process can be implemented. For example, data quality personnel and/or automated programs can logically correct raw (i.e., original) information by appending new rows with cleansed (i.e., corrected) payload column values and new control column values, such as a quality process id in the “add_by” column and a new timestamp in the “as_of” column. Thus corrected data values are available, but uncorrected (original) data values are still available. As an example, this allows data quality measures and trends to be computed for different data sources. As an additional example, corrected data values are easier to identify, thereby making it possible to retransmit only corrected rows, as opposed to a dump of all rows, to downstream dependent systems.

In accordance with the described techniques, data can be targeted towards any data store or data stream, including in-memory or on-disk storage or network transmission. Furthermore, control columns can be added to the natural payload information columns. As described below, a set of non-limiting implementation examples are included which demonstrate implementing these processes using common SQL commands. However, it is to be appreciated and understood that the described techniques are not limited to being implemented using SQL databases. Non-SQL data management systems can also alternatively or additionally be utilized to implement these techniques using, for example, appropriate non-SQL data management commands, transmission commands, program interfaces, and/or software data access layers.

Multiple and varied implementations are described herein. Generally, any of the features/functions described with reference to the figures can be implemented using software, hardware, firmware (e.g., fixed logic circuitry), manual processing, or any combination thereof. The terms “module”, “tool”, and/or “component” as used herein may generally represent software, hardware, firmware, or any combination thereof. For instance, the terms “tool” and “module” may represent software code and/or other types of instructions that perform specified tasks when executed on a computing device or devices.

Generally, the illustrated separation of modules, tools or components and functionality into distinct units may reflect an actual physical grouping and allocation of such software, firmware, and/or hardware. Alternatively or additionally, this illustrated separation may correspond to a conceptual allocation of different tasks to the software, firmware, and/or hardware. Furthermore, it is to be appreciated and understood that the illustrated modules, tools, and/or components and functionality described herein can be located at a single site, or can be distributed over multiple locations.

### Implementation Example

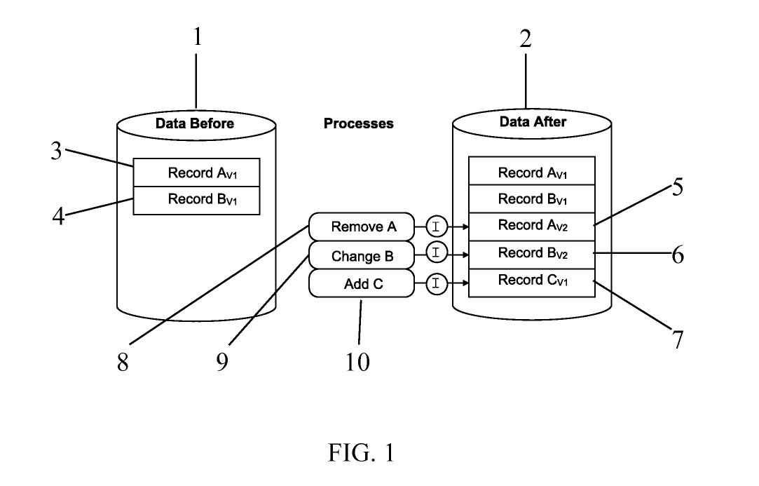

FIG. 1 illustrates example logical data editing processes, or operations, that can be performed in accordance with at least one embodiment. In this example, physical results of a logical erase, a logical change, and a logical add process.

More particularly, as shown here by the append-only process “Remove A” (8), a row designated as “Record A_{V1}” (3) from the “Data Before” image of the data store (1) can be logically erased by inserting a new corresponding superceding row designated as “Record A_{V2}” (5) and setting control column values appropriately (e.g., setting a value in a delete indicating control column). The result is represented here in the “Data After” image of the data store (2).

Alternatively or additionally, as shown here by the append-only process “Change B” (9), a row designated as “Record B_{V1}” (4) from the “Data Before” image of the data store (1) can be logically changed by inserting a new corresponding superceding row designated as “Record B_{V2}” (6) and setting control column values appropriately. The result is represented here in the “Data After” image of the data store (2).

Alternatively or additionally, as shown here by the append-only process “Add C” (10), new information can be logically added by inserting a new row designated as “Record C_{V1}” (7) and setting payload column values with new base information and setting control column values appropriately. The result is represented here in the “Data After” image of the data store (2).

In total, in the example illustrated in FIG. 1 we processed three logical operations via three physical inserts (writes). The processing described in that example can be considered “safe”, in that there is no need to check for redundant or conflicting rows in the data store. Note that it is not necessary to read old data to logically change or even erase old information. Each logical process, or logical operation, resulted in one new row (or record) being added to the data store.

As described above, to differentiate which rows are logical adds, changes or deletes one or more control columns (or fields) can be associated with base data columns (i.e., payload data columns).

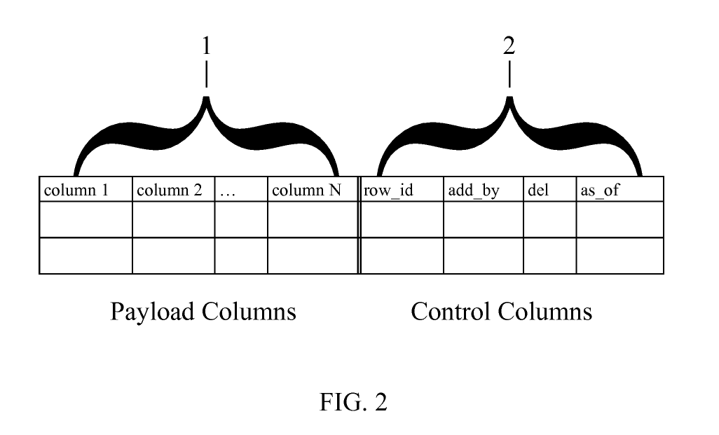

Accordingly, FIG. 2 illustrates an example association of payload data columns with control columns in a data store, in accordance with at least one embodiment. The general columns to the left in group 1 represent the base or payload data columns. These payload columns can be used to represent any type of information. The columns to the right in group 2 represent the control columns that have been associated with the payload columns. In this example association the individual control columns can be identified with the names “row_id”, “add_by”, “del” and “as_of”. However, it is to be appreciated and understood that these names are not limiting, and any suitable names and/or other designations may be used. In addition, it is to be appreciated and understood that the relative positions of the payload data columns and control columns in this example are presented here for illustrative and discussion purposes, and are thus not limiting. As such, individual control columns can be placed before, after, and/or intermixed with individual base or payload data columns. In addition, it is to be appreciated and understood that some control columns are optional and may not be needed by all applications (e.g., if an application does not need to support logical deletes the “del” column is not needed). In addition, it is to be appreciated and understood that some control columns can be implemented and/or extended to several columns (e.g., the simple “add_by” column can be expanded to two columns, “add_by_name” and “add_by_location” to provide more detailed control information). In addition, it is to be appreciated and understood that additional control columns can be added by some embodiments, for example a “sync_timestamp” control column could be added to slave systems which synchronize data from one or more master sources.

In this example, the “row_id” control column may store an identifier which is unique for each physical row. If convenient, auto identifier generation features of a data management system can be used to generate the values of this column. Calculated GUID's (globally unique identifiers) can also be used. Any mechanism capable of generating unique row identifiers could be appropriate. Note that sequential identifier ordering is allowed but not required. In at least one embodiment, the value of this column is restricted from being empty or null. If the data is being saved in a database table this value can often be useful as the primary key or distribution key for the table.

The “as_of” control column, in turn, can store a processing timestamp (date and time) representing the point in time that a row was added. If possible, a timestamp with time zone data type can be recommended so that point in time comparisons will work properly across different time zones. If no time zone support is present, all as_of timestamps (i.e., values in the “as_of” control column) can use UTC (Coordinated Universal Time) or a common time zone that is not affected by daylight savings time adjustments. In at least one embodiment, the value of this column is restricted from being empty or null and the current date/time is the recommended default value. Note that if necessary (e.g., if a data management system does not support combined date, time and time zone timestamps) more than one column can be used to represent “as_of”, such as “as_of_date”, “as_of_time”, and “as_of_timezone”.

The “add_by” control column in this example can store a code that identifies or otherwise describes the source of the new information (e.g., the data source, person or load program that provided the new information). For example, the account name of the computer program adding the data can be stored. If multi-source support is not needed it is acceptable to omit this column, but this is not generally recommended. In at least one embodiment, empty or null values for the column are allowed, but not recommended. Note that if more detailed source information is desired more than one column can be used to represent information source, e.g., “add_by_name”, “add_by_location”, “add_by_vendor”, etc.

The “del” control column in this example can store a true/false boolean flag indicating if the corresponding payload data has been logically erased. The encoding used for this boolean flag is not significant, it can be a character like “T” or “F”, or a number like 0 or 1, or any other suitable encoding type that is convenient. If the default column value is false (which is the recommended default), this indicates that the row contains information to be used. If true, it indicates that the row information has been logically erased—and thus should not be used. If support for logical erase is not desired it is possible to omit this column, but this is not generally recommended. It is also possible to treat and/or name this control column in a different manner, such as naming this column “active” and/or flipping the interpretation of the boolean flag, but the “del” convention will be used in this example.

Payload data from one or more payload data columns typically have a so-called “natural key” formed by one or more column values from the payload data. However, in at least one embodiment the so-called natural key is not to be used as a physical unique primary key. This is because if the information changes there is a physical row for each version of information report for the same natural key. Different versions of this natural key have different “row_id” values, and usually different timestamp values.

As an example, the described techniques can be utilized to maintain (e.g., store) and access (e.g., query) simplified simulated stock market closing price information. In this example, SQL database conventions are used, but it is to be appreciated and understood that other data and data stream systems may be implemented in accordance with the described techniques.

In this example, assume that a particular data vendor “x” provides a daily price file as a comma separated values (CSV) file with three columns:
US ticker symbol.
Closing date.
Closing price in US dollars.

A portion of such a CSV file might look like this:
BLK,2010-02-10,211.13
DIS,2010-02-10,30.03
IBM,2010-02-10,122.81

In at least one embodiment, the vendor supplied information can be captured into a database table with one database column for each raw feed file field, plus the four control columns previously described, row_id, as_of, add_by and del. The DDL to create such a table might be:

| create sequence price_us_vend_x_seq; | | |
|---|---|---|
| create table price_us_vend_x ( | | |
| row_id | bigint | not null default |
| | | nextval(‘price_us_vend_x_seq’), |
| us_tick | varchar(10) | not null, |
| close_date | date | not null, |
| close_usd | float | null, |
| add_by | varchar(20) | not null default current_user, |
| as_of | timestamptz | not null default current_timestamp, |
| del | boolean | not null default false |
| ); | | |

If a bulk load facility is available a typical daily file command could look something like:
<bulkload> price_us_vend_x(us_ticker,close_date,close_usd)
   from ‘/dir/price.20100211.csv’;

Note that the raw data file does not have values for row_id, add_by, as_of or del database columns, however these can all be set by the database system using defaults during the bulk load. The row_id column generally defaults to a unique identifier such that no two rows have the same row_id value. The add by column generally defaults to some value indicating the source of the information, a simple choice is to default to the account username. The as_of column generally defaults to the current date/time. The del column generally defaults to false.

Operational processing can consist of, for instance, simply bulk loading a new file each day. If a vendor resends a daily file with one or more corrections, it can simply be bulk loaded on top of the previous load. Note that this is a very simple and robust process. Accidental duplicated payload data rows generally do not impact the accuracy or usability of the information in the data store.

If ANSI 1999 SQL is not available (no support for the “lead” function) an equivalent, slightly less efficient, ANSI 1992 SQL compatible view definition might be:

```
create view price_us_vend_x_all as
  select a.row_id,a.us_tick,a.close_date,a.close_usd,a.add_by,
    a.del,a.as_of,min(b.as_of) as next_as_of
  from price_us_vend_x as a left outer join price_us_vend_x as b
  on a.us_tick=b.us_tick and a.close_date=b.close_date and
  a.as_of<b.as_of group by a.row_id,a.us_tick,a.close_date,
  a.close_usd,a.add_by,a.del,a.as_of
;
```

In this example, this view shows all rows and the “next_as_of” field will be null for most recent row versions. To see just the active rows, select from the “all” view above with the condition “next_as_of is null and del=false”. This can be encapsulated in a “now” view which displays only active rows as follows:

```
create view price_us_vend_x_now as
  select row_id,us_tick,close_date,close_usd,add_by,as_of
  from price_us_vend_x_all
  where next_as_of is null and del=false
;
```

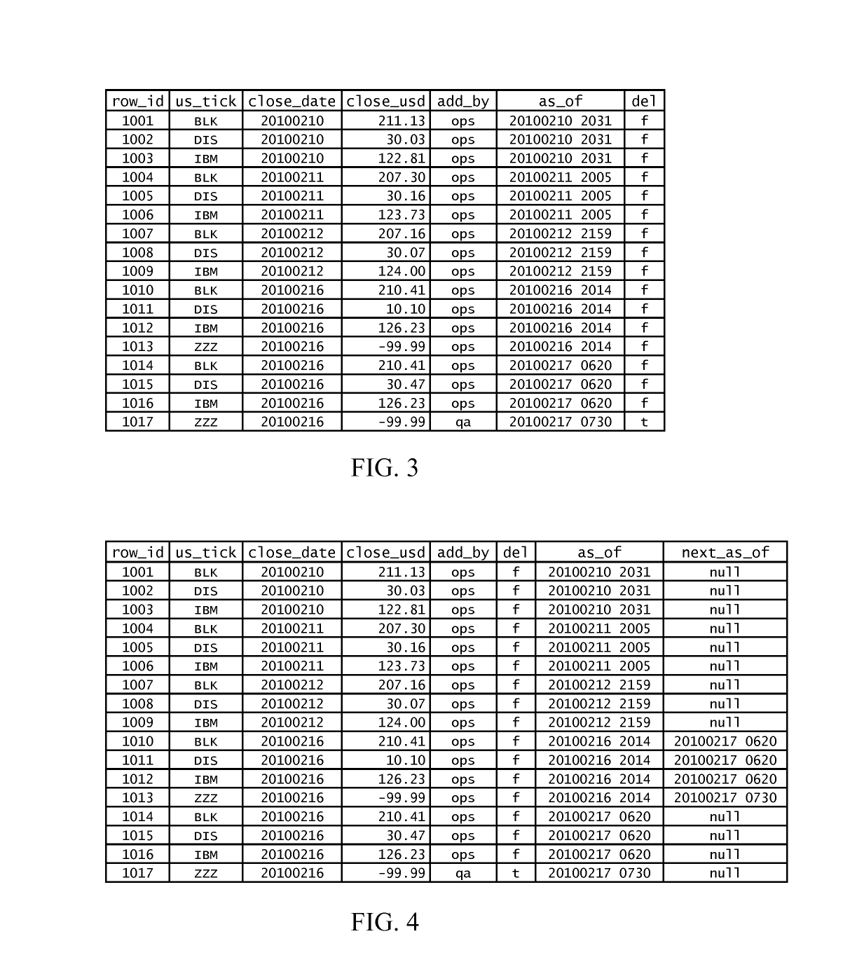

For purposes of discussion, assume that in this example this approach was used to load data for Feb. 10th, 11th, 12th and 16th of 2010. Furthermore, assume that on the 16th, the data vendor retransmitted the daily file with some data corrections after the initial load and that this corrected file was also loaded. The state of this database table is represented in FIG. 3.

From FIG. 3, note that in this example this sample feed is providing daily closing prices for three stocks (BLK, DIS and IBM). The natural key is ticker and closing date. On the 10th prices were loaded into the database at about 8:31 PM. (rows 1001 through 1003). On the 11th prices were loaded a little earlier, around 8:05 PM. On the 12th the data did not get loaded until 9:59 PM. On the 16th we see the effect of the corrections file. At 8:14 PM the original daily file with prices for the 16th was loaded. However, note that the corrected file was loaded at 6:20 AM of the 17th with a new price for DIS. In addition note that data QA spotted a bogus entry for ZZZ with a negative price. Thus, the bogus entry was logically deleted at 7:30 AM.

When using these techniques to save changes an old “version” of a row can be superseded by a more recent row with updated values. To logically erase information, an additional row can be added to indicate that as well. One sometimes wants to submit queries which only consider the most recent, not-logically erased rows. At other times one may want a query to show information “as of” a particular point in time. At still other times one may want to see a history of changes. Sometimes one may want to see data before data quality cleansing, sometimes after. By utilizing the described techniques, these queries and many more can be performed and optionally, database views can be used to make these queries easy to repeat.

Each row can have an “as_of” column that indicates the timestamp when that data became valid, in effect a “begin” timestamp. The data is valid until another row with the same natural key is added to supersede it, the “as_of” column of the superseding row being the effective “end” or “next” timestamp for the previous corresponding entry. The current, most recent versions of each row have no “end” or “next” timestamp, although for convenient querying it may be useful to use a far-future timestamp date, rather than a null value. For easy and efficient queries, in at least one embodiment both the begin and end as_of value can be available on the same logical row, even though they are on two different physical rows.

If ANSI 1999 SQL is available the SQL analytical “lead . . . over” function can be used to efficiently determine the next_as_of value, if any, for each row. If only ANSI 1992 is supported the same effect can be achieved by self-joining the table and using group by. This logic can be placed in a view definition for convenience. The sample “price_us_vend_x” table seen previously (see FIG. 3) can be used to illustrate this.

The ANSI 1999 SQL standard view definition might be:

```
create view price_us_vend_x_all as
  select row_id,us_tick,close_date,close_usd,add_by,del,as_of,
  lead(as_of) over(partition by us_tick,close_date order by as_of asc)
  as next_as_of
  from price_us_vend_x
;
```

It is sometimes convenient to query as of data as a date range, but the occasional null value for next_as_of in most current rows can complicate this. To make historical as of querying easier this can be replace with an arbitrary far future date. This can be encapsulated in a historical change view as follows:

```
create view price_us_vend_x_hst as
  select row_id,us_tick,close_date,close_usd,add_by,del,as_of,
  case
    when next_as_of is null then timestamp(‘9999-12-31 00:00:00’)
    else next_as_of
  end as next_as_of
  from price_us_vend_x_all
;
```

We can now use these views to query some data, still assuming the table is populated with data as shown in FIG. 3.

A simple query on the “all” view displays all records with the addition of the next_as_of column:
select * from price_us_vend_x_all;

Returns the data shown in FIG. 4.

This same data can be viewed with nulls replace by a far future date using the “hst” view:
select * from price_us_vend_x_hst;

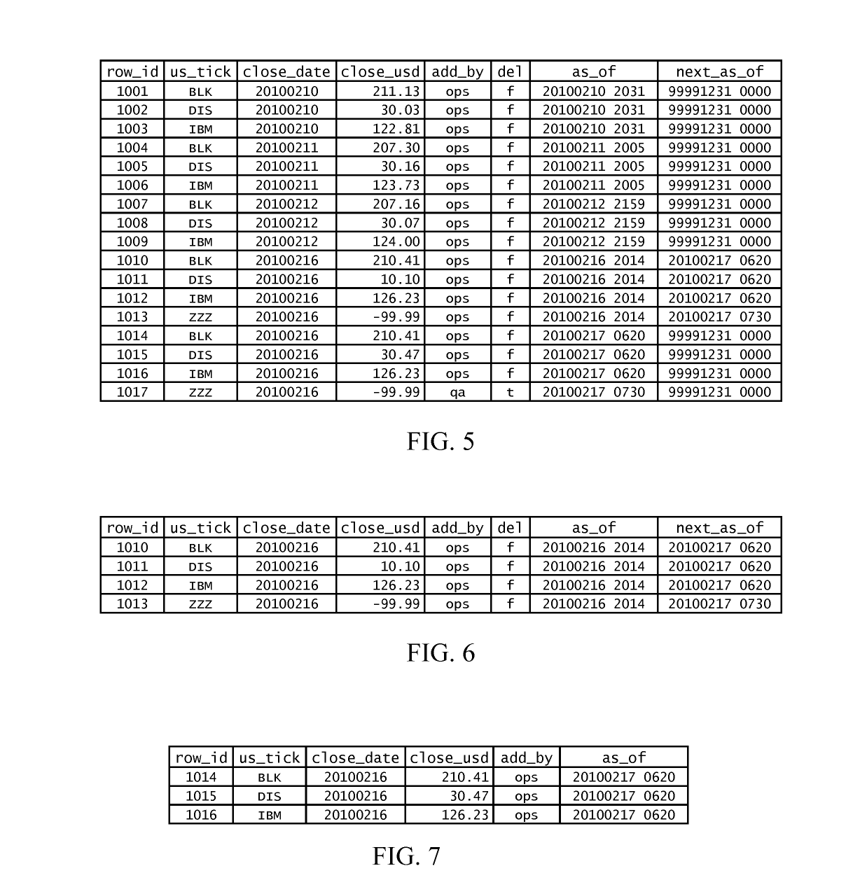

Returns the data shown in FIG. 5.

Data “as when” some point in time as follows:

select * from price_us_vend_x_hst where close_date=‘2010-02-16’

and ‘2010-02-17 06:00’>=as_of and ‘2010-02-17 06:00’<next_as_of and del=f;

Returns the data shown in FIG. 6.

The current active view of history can be queried using the “now” view as follows:

select * from price_us_vend_x_now where close_date=‘2010-02-16’;

Returns the data shown in FIG. 7.

Note that the record for “DIS” on the 16th with the erroneous closing price, $10.10, was not returned, only the more up-to-date corrected price for the 16th, $30.47. Also note that the logically deleted entry for “ZZZ” was not returned.

If it is desired to filter or select based on the source of the information the add by column can be used. For example, to see the data without any data quality corrections the following “dirty” view which excludes add_by=“qa” rows could be used.

```
create view price_us_vend_x_dirty as
  select row_id,us_tick,close_date,close_usd,add_by,del,as_of,
  lead(as_of) over(partition by us_tick,close_date
  order by as_of asc) as next_as_of
  from price_us_vend_x
  where add_by != ‘qa’
;
```

If a target data management system does not support SQL the previous SQL logic or equivalent can be implemented in the system's native query language or as part of the application data access layer.

### Data Synchronization Example

For scalability data can be synchronized between two or more systems. Note that the techniques describe herein are especially suited to data synchronization environments, for example because duplicate payload data rows are generally not a problem (mitigating row collision problems) and because logical data removes, logical data changes, and logical data adds are all implemented as physical inserts (appends).

In one simple embodiment, data synchronization can be implemented by periodically extracting all rows since a designated threshold timestamp value of the as_of control column and transmitting those rows (both payload column values and control column values) to a target system. The target system may then load these extracted records preserving the values of both payload and control columns (unlike a raw load from an external source where control column values are calculated or defaulted). After each successful synchronization the threshold timestamp value may be increased. Using this simple embodiment it can be easy to create simple and robust master/slaves configurations. Data queries can be spread to all systems, although data changes should generally always be initiated at the master.

In a slightly more flexible and advanced embodiment, robust, easy to maintain peer-to-peer synchronization configurations are possible. This has the advantage of eliminating the single master point of failure (greatly improving reliability) and also allows data change requests, not just queries, to be spread across multiple systems. In one embodiment of this more advanced approach an additional “sync_timestamp” control column can be used. When data is loaded from an external source (not a synchronization source) the sync_timestamp control column is null or empty. When data is loaded from a synchronization source the synch_timestamp control column is set to the date/time the synchronization data is loaded. As an example, consider two systems designated as “System A” and “System B”, each system with its own independent data store, and we want to synchronize System A to System B and System B to System A in a peer-to-peer fashion. One way to do this is for each system to periodically request synchronization data from the other since some threshold timestamp. When a system receives a request for synchronization data since some threshold timestamp it extracts all rows with an empty or null “sync_timestamp” control column value that also have a “as_of” control column value greater than the requested threshold timestamp and transmit the extracted rows to the requesting system along with the actual date/time the extraction was performed. Only extracting rows with null “sync_timestamp” means only rows originally loaded from external sources are extracted, preventing transmitting rows back that were received as synchronization rows. When a system receives extracted rows from another system it loads those records into its local data store as is, except that the “sync_timestamp” of each row should be set to the extraction date/time that accompanied the extracted data. In addition the extraction date/time should be saved and used as the new threshold timestamp for the next periodic synchronization request. Note that it is also important for System A and System B to have internal time clocks which track time relatively close to each other.

### Example Data De-Duplication

The techniques described previously are very forgiving of rows with duplicate payload data values because such duplicates are always consolidated when using the demonstrated query techniques (in other words physical data duplication does not result in logical data duplication). However, physical duplicate data does require additional storage space and may also slightly slow down queries. It is often optimal to simply ignore physical duplication, e.g., such duplicates do tell data quality personnel something about processing effectiveness. To do data de-duplication effectively may be a big operation that probably should only be done during scheduled maintenance windows. An effective de-duplication method is to create a new empty data store and then load only non-duplicate data from the old data store to the new.

### Example System and Environment

The techniques described herein can be implemented in any suitable way. In at least one embodiment, for instance, some or all of these techniques can be implemented at least in part by a system (e.g., data management system) that includes a data management tool.

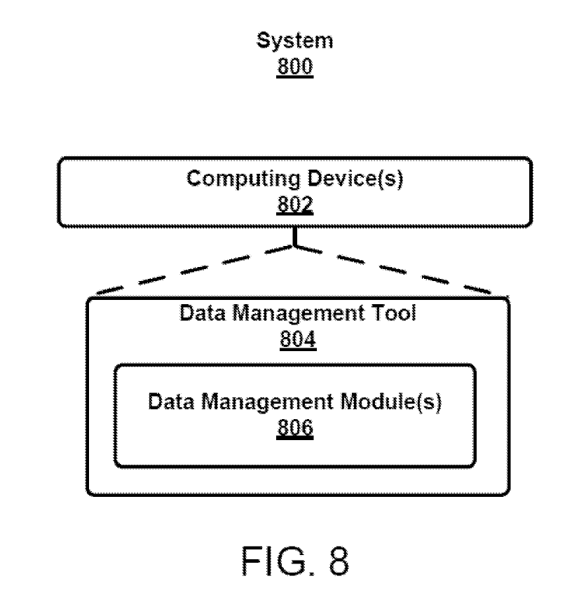

For example, FIG. 8 illustrates an example system 800 in which the described techniques can be implemented, in accordance with at least one embodiment. In this example, the environment 800 includes one or more computing devices 802. Computing Device(s) 802 can include any number and type(s) of computing device(s).

In this regard, the term “computing device”, as used herein, can mean any type of device or devices having some amount of processing capability. Examples of computing devices can include traditional computing devices, such as personal computers (desktop, portable laptop, etc.), cell phones, server computing devices, tablets, smart phones, personal digital assistants, or any suitable type(s) of computing devices.

Computing device(s) 802 can indirectly and/or directly exchange data via one or more network(s) and/or by any other suitable means, such as via an external storage for instance. Without limitation, the network(s) can include one or more local area networks (LANs), wide area networks (WANs), the Internet, and/or the like. Examples of the storage devices can include magnetic disk drive, optical storage devices (e.g., CDs, DVDs etc.) and flash storage devices (e.g., memory sticks or memory cards), web drives, among others.

Additionally or alternatively, one or more individual computing devices of the computing device(s) 802 can be configured to exchange data network connected resources with other resources associated with the cloud—via the network(s) for instance. As used herein, the cloud refers to computing-related resources/functionalities that can be accessed via the network(s), although the location of these computing resources and functionalities may not be readily apparent.

Here, one or more individual computing devices of the computing device(s) 802 may include a processor(s) (i.e., central processing unit(s)) and storage. The processor(s) may execute data in the form of computer-readable instructions to provide the functionality described herein. Data, such as computer-readable instructions, can be stored on storage associated with one or more individual computing devices of the computing device(s) 802.

One or more individual computing devices of the computing device(s) 802 can be configured to receive and/or generate data in the form of computer-readable instructions from one or more other storage devices. The computing devices can also receive data in the form of computer-readable instructions over the network(s) that are then stored on the computing device(s) for execution by the processor(s).

As used herein, the term “computer-readable media” can include transitory and non transitory instructions. In contrast, the term “computer-readable storage media” excludes transitory instances. Computer-readable storage media can include “computer-readable storage devices”. Examples of computer-readable storage devices include volatile storage media, such as RAM, and non-volatile storage media, such as hard drives, optical discs, and flash memory, among others.

In this example, the system 800 also includes a data management tool 804 that can be configured to be implemented at least in part by the computing device (802). In at least one embodiment, the data management tool 804 can be utilized to implement some or all of the described techniques. For example, here the data management tool 804 includes one or more data management modules 806 that can be configured to perform processes, or operations, for representing, editing, and/or accessing data, as described in detail above.

In at least one embodiment, a single computing device of computing device(s) 802 can function in a stand-alone configuration such that all of the data management tool 804 is implemented by the single computing device. In other embodiments however, at least part of the data management system can be implemented using other resources provided by one or more other individual computing devices of computing device(s) 802, the cloud, and/or one or more other suitable computing-related resources/functionalities.

I claim:

1. A method comprising: associating one or more control columns with data in a data store; and utilizing the one or more control columns to edit and/or query the data.

2. The method of claim 1, wherein to logically edit the data comprises at least one of: logically adding data to the data store, logically changing data in the data store, or logically deleting data in the data store.

3. The method of claim 2, wherein to physically edit the data further comprises utilizing a physical append operation(s) to insert a new record(s) into the data store regardless of whether the logical edit was a logical add, logical change or logical delete.

4. The method of claim 3, wherein utilizing the one or more control columns comprises setting a value in one or more control columns.

5. The method of claim 4, wherein the control column fields correspond to a record in the data store.

6. The method of claim 4, wherein the control column values indicate if information has been logically erased; provides a timestamp for data edits; uniquely identifies the information record; or identifies a source of the information record.

7. A system comprising: at least one computing device; and a data management tool and/or software layer configured to: represent data in a data store by associating one or more control columns with the data; and utilizing the one or more control columns to one or both of: edit the data or access the data.

8. The system of claim 7, wherein the data management tool and/or software layer is configured to logically edit the data with an physical append-only operation.

9. The system of claim 7, wherein the data management tool and/or software layer is configured to access the data by querying the data to identify current information, information as of a certain point in time, information changes over time, or information from select sources.

10. The system of claim 10, wherein utilizing the one or more control columns to access the data comprises utilizing a value in one or more control columns to identify the current information, the information as of the certain point in time, the information changes over time, or information from select sources.

11. A method of claim 1, to propagate and/or synchronize add/change/delete transactions to other systems which requires only data appends at the receiver end.

12. A method of claim 1, wherein data quality data corrections can be inserted while still preserving original uncorrected values.

13. A method of claim 1, wherein data and/or processing quality metrics and trends can be computed.
